(19) United States
(12) Patent Application Publication
(10) Pub. No.: US 2024/0377068 A1
(43) Pub. Date: Nov. 14, 2024

(54) COOKING APPARATUS

(71) Applicant: SAMSUNG ELECTRONICS CO., LTD., Suwon-si (KR)

(72) Inventors: Sunwoo HAN, Suwon-si (KR); Hyeongjin JANG, Suwon-si (KR); Soonmin LIM, Suwon-si (KR); Eunji JO, Suwon-si (KR); Byounghoon MOON, Suwon-si (KR); Sangwon LEE, Suwon-si (KR)

(73) Assignee: SAMSUNG ELECTRONICS CO., LTD., Suwon-si (KR)

(21) Appl. No.: 18/596,960

(22) Filed: Mar. 6, 2024

Related U.S. Application Data
(63) Continuation of application No. PCT/KR2024/001526, filed on Feb. 1, 2024.

(30) Foreign Application Priority Data
May 9, 2023 (KR) 10-2023-0060180
Aug. 28, 2023 (KR) 10-2023-0113201

(51) Int. Cl. F24C 3/08; F23D 14/04

(52) U.S. Cl. CPC F24C 3/087; F23D 14/04; F23D 2210/00

(57) ABSTRACT

A cooking apparatus can include a main body including at least one opening, the main body forming a cooking chamber, a burner in the main body to heat the cooking chamber, and a silencer mounted to the main body and covering the at least one opening so that: air from an outside of the main body is passable through the silencer and the at least one opening to be supplied to the burner, and noise generated by the burner, and discharged through the silencer and the at least one opening to the outside of the main body, is reduced by the silencer.

### CROSS-REFERENCE TO RELATED APPLICATIONS

This is a continuation application of International Application No. PCT/KR2024/001526, filed Feb. 1, 2024, which is incorporated herein by reference in its entirety, it being further noted that foreign priority benefit is based upon Korean Patent Application Nos. 10-2023-0060180, filed May 9, 2023, and 10-2023-0113201, filed Aug. 28, 2023, which are incorporated by reference herein in their entireties.

### TECHNICAL FIELD

The disclosure relates to a cooking apparatus equipped with a burner that generates heat by burning a gas fuel and air.

### BACKGROUND ART

A cooking apparatus is an appliance for heating and cooking an object to be cooked such as food, and is capable of performing various functions related to cooking, such as heating, defrosting, drying, and sterilizing the object to be cooked. Examples of such a cooking apparatus include an oven, such as a gas oven or an electric oven, a microwave heating device (hereinafter referred to as a microwave), a gas range, an electric range, a gas grill, or an electric grill.

An oven is a device for cooking food by transferring heat directly to the food or by heating the inside of a cooking chamber by means of a heat source such as a heater. A microwave is a device for cooking food using frictional heat generated by disturbing the arrangement of molecules in the food with electromagnetic waves as a heat source.

A gas oven is an appliance to cook food by heating food in a cooking chamber, and includes a cooking chamber, a burner that generates heat by burning a gas fuel and air, a gas supply flow path that supplies gas to the burner, and an ignition device that generates a flame.

### DISCLOSURE

### Technical Problem

According to an aspect of the disclosure, a cooking apparatus may reduce noise generated when burner flame is extinguished.

According to an aspect of the disclosure, a cooking apparatus may prevent sparks from burner flame from being discharged to the outside.

According to an aspect of the disclosure, a cooking apparatus may prevent oil or food debris from the food from being discharged to the outside.

Technical objects that can be achieved by the disclosure are not limited to the above-mentioned objects, and other technical objects not mentioned will be clearly understood by one of ordinary skill in the art to which the disclosure belongs from the following description.

### Technical Solution

According to an aspect of the disclosure, a cooking apparatus can include: a main body including at least one opening, the main body forming a cooking chamber, a burner in the main body to heat the cooking chamber, and a silencer mounted to the main body and covering the at least one opening so that: air from an outside of the main body can be passable through the silencer and the at least one opening to be supplied to the burner, and noise generated by the burner, and discharged through the silencer and the at least one opening to the outside of the main body, can be reduced by the silencer.

According to an aspect of the disclosure, the silencer can include: a first noise guide configured to guide the noise, discharged through the silencer and the at least one opening, in a first direction, and a second noise guide configured to guide noise, guided by the first noise guide, in a second direction different from the first direction.

According to an aspect of the disclosure, the cooking apparatus can further include: a first flow path along which the noise, discharged through the silencer and the at least one opening, can be guided by the first noise guide; and a second flow path along which the noise, guided by the first noise guide, can be guided by the second noise guide.

According to an aspect of the disclosure, the cooking apparatus can further include: a sound absorbing member disposed in the second flow path so that noise, guided by the second noise guide along the second flow path, can be absorbed by the sound absorbing member.

According to an aspect of the disclosure, the sound absorbing member can include a flame-retardant material.

According to an aspect of the disclosure, the first flow path can be formed by the main body and the first noise guide, and the second flow path can be formed by the first noise guide and the second noise guide.

According to an aspect of the disclosure, the first noise guide can include: a first guide body spaced apart from a bottom surface of the main body, and a first blocking portion extended toward the main body to prevent a substance in the first flow path from being discharged in the second direction from the first flow path to an outside of the silencer, and the second noise guide can include: a second guide body spaced apart from the first guide body, and a second blocking portion extended toward the main body to prevent a substance in the second flow path from being discharged in the first direction from the second flow path to the outside of the silencer.

According to an aspect of the disclosure, the cooking apparatus can further comprise: a first sealing member configured to seal a gap between the main body and the first blocking portion to prevent noise, guided by the first noise guide along the first flow path, from being discharged in the second direction from the first flow path to the outside of the silencer through the gap.

According to an aspect of the disclosure, the cooking apparatus can further include: a second sealing member configured to seal a gap between the main body and the second blocking portion to prevent noise, guided by the second noise guide along the second flow path, from being discharged in the first direction from the second flow path to the outside of the silencer through the gap.

According to an aspect of the disclosure, the first noise guide can include a first prevention portion extending toward the main body to prevent a portion of a substance moved in the first flow path from moving to the second noise guide.

According to an aspect of the disclosure, the second noise guide can include a second prevention portion extending toward the main body to prevent a portion of a substance moved in the second flow path from being discharged from the second noise guide.

According to an aspect of the disclosure, the at least one opening can be located below the burner in a direction of gravity, the first noise guide can be located below the at least one opening in the direction of gravity, and the second noise guide can be located below the first noise guide in the direction of gravity.

According to an aspect of the disclosure, the cooking apparatus can further include: a burner case located below the cooking chamber to accommodate the burner, wherein the burner case comprises a case opening formed to discharge the noise generated by the burner toward the at least one opening.

According to an aspect of the disclosure, the burner can be located below the cooking chamber in a direction of gravity.

According to an aspect of the disclosure, the first noise guide can be coupled to the second noise guide, and the second noise guide can be coupled to the main body.

According to an aspect of the disclosure, a cooking apparatus can include: a main body including at least one opening, the main body forming a cooking chamber; a burner below the cooking chamber to heat the cooking chamber; and a silencer mounted to the main body and covering the at least one opening to reduce noise discharged to an outside of the main body through the silencer and the at least one opening and including a guide body spaced apart from a bottom surface of the main body and a blocking portion configured to limit a discharge direction so as to discharge a substance discharged to the outside of the main body in a preset direction.

According to an aspect of the disclosure, a cooking apparatus can include: a main body including at least one opening, the main body forming a cooking chamber; a burner below the cooking chamber to heat the cooking chamber; the at least one opening located below the burner to supply air to the burner; a first noise guide located below the at least one opening and configured to form a first flow path for guiding noise, discharged to an outside of the main body through the at least one opening, in a first direction; and a second noise guide configured to form a second flow path for guiding the noise, guided by the first nose guide, in a second direction different from the first direction.

### DESCRIPTION OF DRAWINGS

FIG. 1 illustrates a cooking apparatus according to an embodiment of the disclosure.

FIG. 2 illustrates a front view of a cooking apparatus with a door open according to an embodiment of the disclosure.

FIG. 3 illustrates an inside of a burner case located below a cooking chamber of a cooking apparatus according to an embodiment of the disclosure.

FIG. 4 illustrates a lower portion of a cooking apparatus according to an embodiment of the disclosure.

FIG. 5 illustrates a state where a silencer of a cooking apparatus according to an embodiment of the disclosure is disassembled, as viewed from below.

FIG. 6 illustrates a state where a silencer of a cooking apparatus according to an embodiment of the disclosure is disassembled, as viewed from above.

FIG. 7 illustrates a cross sectional view of the cooking apparatus shown in FIG. 4 taken along line A-A′.

FIG. 8 illustrates a partial cross sectional view of a cooking apparatus including a silencer according to an embodiment of the disclosure.

FIG. 9 illustrates a partial cross sectional view of a cooking apparatus including a silencer according to an embodiment of the disclosure.

FIG. 10 illustrates a partial cross sectional view of a cooking apparatus including a silencer according to an embodiment of the disclosure.

FIG. 11 illustrates a partial cross sectional view of a cooking apparatus including a silencer according to an embodiment of the disclosure.

### MODES OF THE DISCLOSURE

Embodiments described in the specification and configurations shown in the accompanying drawings are merely examples of the disclosure, and various modifications may replace the embodiments and the drawings of the disclosure at the time of filing of the application.

Like reference numerals or symbols denoted in the drawings of the specification are members or components that perform the approximately same functions.

A singular form of a noun corresponding to an item may include one item or a plurality of the items unless context clearly indicates otherwise.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

The term “and/or” includes any and all combinations of one or more of a plurality of associated listed items.

It will be understood that the terms “first”, “second”, etc., may be used only to distinguish one component from another, not intended to limit the corresponding component in other aspects (e.g., importance or order).

When it is said that one (e.g., first) component is “coupled” or “connected” to another (e.g., second) component, with or without the terms “functionally” or “communicatively”, it means that one component can be connected to the other component directly (e.g., by wire), wirelessly, or through a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

An expression that one component is “connected”, “coupled”, “supported”, or “in contact” with another component includes a case in which the components are directly “connected”, “coupled”, “supported”, or “in contact” with each other and a case in which the components are indirectly “connected”, “coupled”, “supported”, or “in contact” with each other through a third component.

It will also be understood that when one component is referred to as being “on” or “over” another component, it can be directly on the other component or intervening components may also be present.

The terms “front (forward),” “rear (backward),” “left,” “right,” “up (upper),”, “down (lower),” etc., used in the following description are defined based on the drawings, and the shape and position of each component are not limited by these terms.

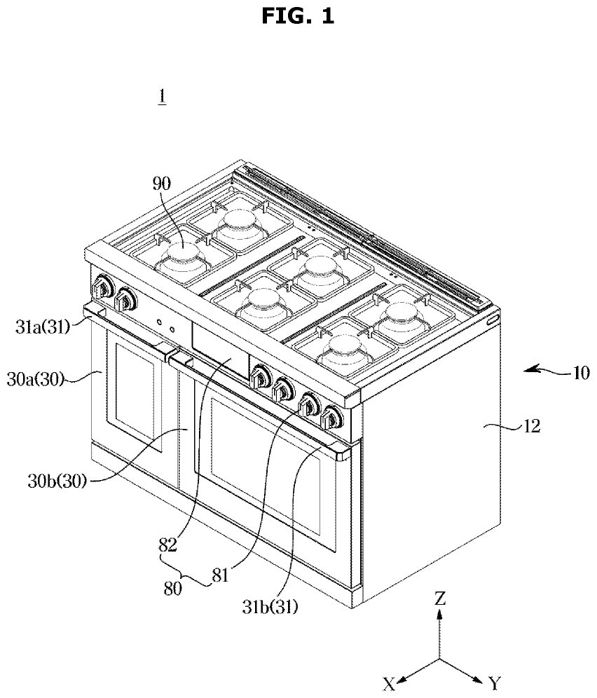

For example, in FIG. 1, an X direction may be defined as front-to-back, a Y direction may be defined as left-to-right, and Z direction may be defined as up-down, but the shape and position of each component is not limited by these terms.

Hereinafter, embodiments of the disclosure are described in detail with reference to the accompanying drawings.

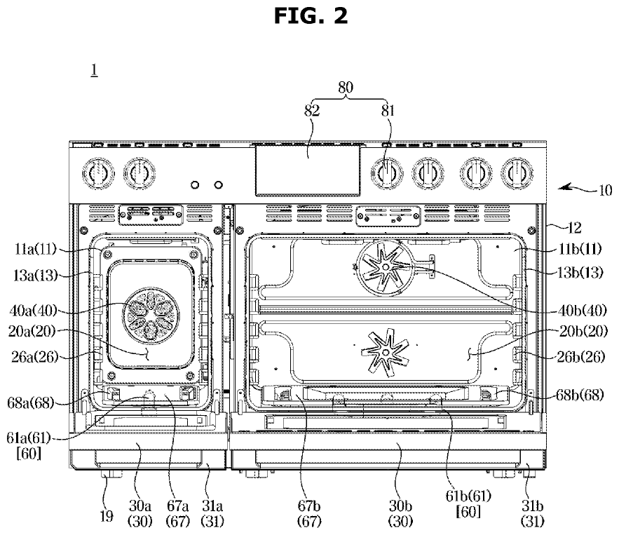

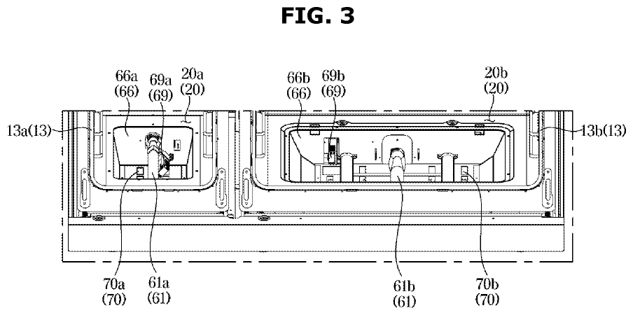

FIG. 1 illustrates a cooking apparatus according to an embodiment. FIG. 2 illustrates a front view of a cooking apparatus with a door open according to an embodiment. FIG. 3 illustrates an inside of a burner case located below a cooking chamber of a cooking apparatus according to an embodiment.

Referring to FIG. 1 to FIG. 3, a cooking apparatus 1 according to an embodiment may include a main body 10. A variety of components may be mounted and/or accommodated in the main body 10. The main body 10 may include an inner case 11 and an outer case 12.

The outer case 12 may be disposed outside the inner case 11. The inner case 11 may be accommodated in the outer case 12. The outer case 12 may include a material different from the inner case 11. The outer case 12 may form an exterior of the cooking apparatus 1.

An insulator may be arranged between the inner case 11 and the outer case 12 to delay heat transfer from the inside of a cooking chamber 20 to the outside.

Legs 19 may be arranged at a lower portion of the main body 10 to support the main body 10.

The cooking apparatus 1 may include a cooktop burner 90. The cooktop burner 90 may be disposed on an upper surface of the outer case 12. The cooktop burner 90 may be configured to cook food using a gas fuel. A user may cook food by placing a cooking container with food on the cooktop burner 90.

The cooking apparatus 1 may include a user interface 80. The user interface 80 may be disposed on a front surface of the outer case 12. The user interface 80 may include a control knob 81 that may be operated by a user to control the cooking apparatus 1. The user interface 80 may include a display 82 for displaying a state of the cooking apparatus 1 to the user.

The cooking apparatus 1 may include a cooking chamber 20 for accommodating food to be cooked. For example, the cooking chamber 20 may include a first cooking chamber 20a and a second cooking chamber 20b having a larger size than the first cooking chamber 20a.

The inner case 11 may form the cooking chamber 20. The inner case 11 may include a first inner case 11a for forming the first cooking chamber 20a and a second inner case 11b for forming the second cooking chamber 20b.

The inner case 11 may be coated to prevent corrosion caused by condensation of water vapor or moisture contained in the food itself.

The main body 10 may include an opening portion 13 for putting food into the cooking chamber 20 or taking food out from the cooking chamber 20. The opening portion 13 may include a first opening portion 13a for the first cooking chamber 20a and a second opening portion 13b for the second cooking chamber 20b.

The cooking apparatus 1 may include a door 30 for opening and closing the cooking chamber 20. The door 30 may include a first door 30a for the first cooking chamber 20a and a second door 30b for the second cooking chamber 20b.

The door 30 may cover the opening portion 13. The door 30 may be rotatably coupled to the main body 10. The door 30 may include a transparent or translucent material to allow a user to view the inside of the cooking chamber 20 from the outside while the opening portion 13 is covered.

The cooking apparatus 1 may include a handle 31 on the door 30. The handle 31 may include a first handle 31a provided on the first door 30a and a second handle 31b provided on the second door 30b. A user may open or close the door 30 using the handle 31.

The cooking apparatus 1 may include a tray supporter 26 for a tray that may be detachably mounted in the cooking chamber 20. The tray supporter 26 may include a first tray supporter 26a for the first cooking chamber 20a and a second tray supporter 26b for the second cooking chamber 20b. The tray containing food may be supported by the tray supporter 26 and may be accommodated in the cooking chamber 20.

The cooking apparatus 1 may include a fan 40. The fan 40 may include a first fan 40a for the first cooking chamber 20a and a second fan 40b for the second cooking chamber 20b. The fan 40 may be located at a rear portion of the cooking chamber 20. The fan 40 may circulate the air in the cooking chamber 20 to heat the food evenly.

The cooking apparatus 1 may include a burner 60 for heating the cooking chamber 20. The burner 60 may include a first burner 60a for the first cooking chamber 20a and a second burner 60b for the second cooking chamber 20b. The burner 60 may heat the inside of the cooking chamber 20 by burning a gas fuel.

The burner 60 may include a lower burner 61 located at a lower portion of the cooking chamber 20. The lower burner 61 may include a first lower burner 61a for the first cooking chamber 20a and a second lower burner 61b for the second cooking chamber 20b.

The lower burner 61 may include an ignition device 69 to ignite a gas fuel. The ignition device 69 may include a first ignition device 69a for the first lower burner 61a and a second ignition device 69b for the second lower burner 61b.

The cooking apparatus 1 may include a burner case 66 to accommodate the lower burner 61. The burner case 66 may include a first burner case 66a for accommodating the first lower burner 61a and a second burner case 66b for accommodating the second lower burner 61b.

The burner case 66 may include a case opening 70 for supplying air to the lower burner 61. The case opening 70 may include a first case opening 70a for the first lower burner 61a and a second case opening 70b for the second lower burner 61b.

The cooking apparatus 1 may include a burner cover 67 for covering an upper portion of the burner case 66. The burner cover 67 may include a first burner cover 67a to cover an upper portion of the first burner case 66a, and a second burner cover 67b to cover an upper portion of the second burner case 66b.

The burner cover 67 may include a heat supply portion 68 to supply heat generated in the lower burner 61 to the cooking chamber 20. The heat supply portion 68 may include a first heat supply portion 68a provided in the first burner cover 67a and a second heat supply portion 68b provided in the second burner cover 67b.

The burner 60 may include an upper burner 62 located at an upper portion of the cooking chamber 20. The upper burner 62 may include a first upper burner 62a for the first cooking chamber 20a and a second upper burner 62b for the second cooking chamber 20b. The upper burner 62 may be omitted.

The first lower burner 61a for heating the first cooking chamber 20a, which is relatively small, has a shorter flow path through which noise generated when flame is extinguished is discharged, compared to the second lower burner 61b for heating the second cooking chamber 20b which is relatively large. Accordingly, the noise discharged to the outside of the cooking apparatus 1 becomes louder.

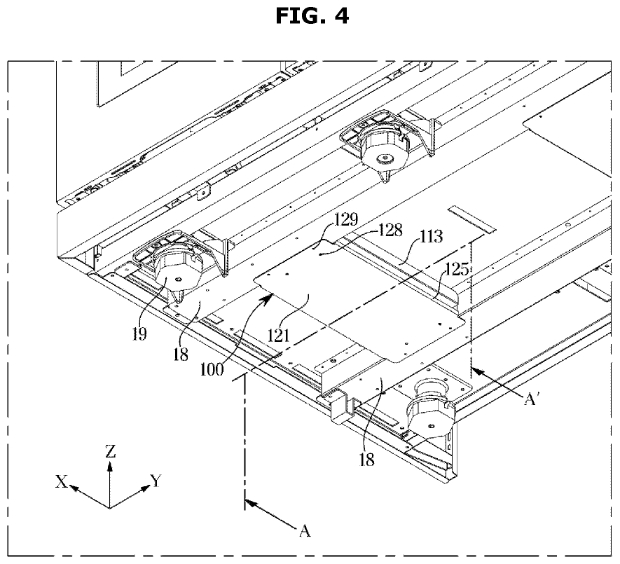

To overcome the above, the cooking apparatus 1 according to an embodiment of the disclosure includes a silencer 100 (see FIG. 4).

Although FIG. 1 to FIG. 3 show that the silencer 100 is applied to the cooking apparatus 1 including the first cooking chamber 20a and the second cooking chamber 20b, the silencer 100 according to the disclosure is not limited thereto. The silencer 100 may be applied to a cooking apparatus including a single cooking chamber and a cooking apparatus including three or more cooking chambers.

Hereinafter, although the silencer 100 according to an embodiment of the disclosure is described as being provided for the first lower burner 61a for the first cooking chamber 20a having a relatively small size, the silencer 100 according to the disclosure is not limited thereto. That is, the silencer 100 may be provided for the second lower burner 61b for the second cooking chamber 20b which has a relatively large size. In addition, the silencer 100 according to the disclosure may be provided for both the first lower burner 61a for the first cooking chamber 20a and the second lower burner 61b for the second cooking chamber 20b.

Furthermore, for convenience of description, the first cooking chamber 20a of the cooking apparatus 1 according to an embodiment is referred to as the cooking chamber 20, the first lower burner 61a is referred to as the burner 61, the first burner case 66a is referred to as the burner case 66, the first burner cover 67a is referred to as the burner cover 67, the first heat supply portion 68a is referred to as the heat supply portion 68, the first ignition device 69a is referred to as the ignition device 69, and the first case opening 70a is referred to as the case opening 70.

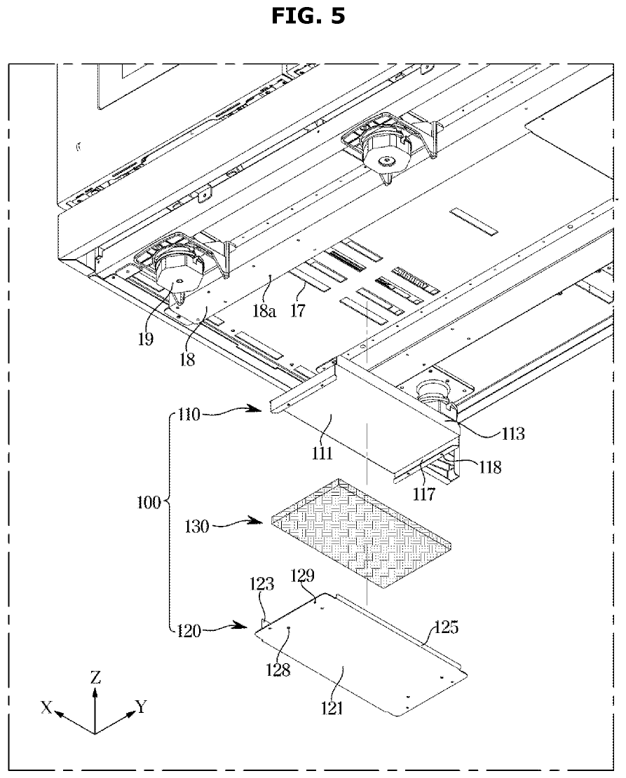

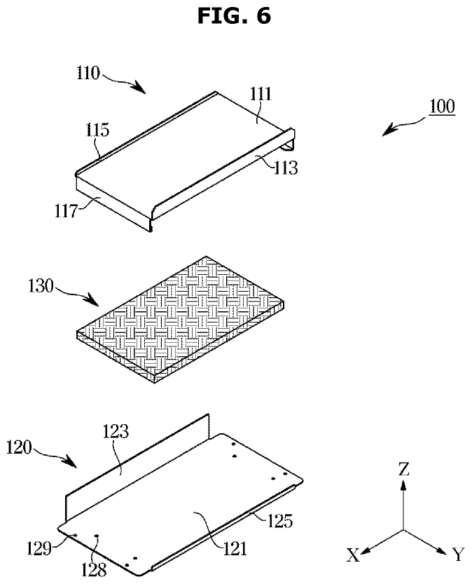

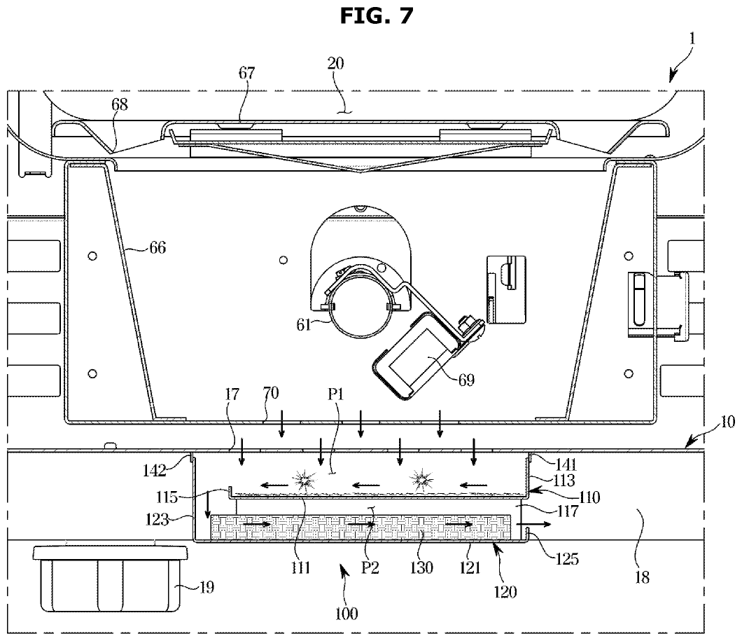

FIG. 4 illustrates a lower portion of a cooking apparatus according to an embodiment. FIG. 5 illustrates a state where a silencer of a cooking apparatus according to an embodiment is disassembled, as viewed from below. FIG. 6 illustrates a state where a silencer of a cooking apparatus according to an embodiment is disassembled, as viewed from above. FIG. 7 illustrates a cross sectional view of the cooking apparatus shown in FIG. 4 taken along line A-A′.

Referring to FIG. 4 to FIG. 6, the cooking apparatus 1 may include a passage portion 17. The passage portion 17 may be formed in a lower portion of the main body 10. The passage portion 17 may be located below the burner 61 in the direction of gravity. The passage portion 17 may be provided to supply air for combustion to the burner 61. The passage portion 17 may communicate the inside of the main body 10 with the outside of the main body 10. The passage portion 17 may include at least one opening.

The cooking apparatus 1 may include the silencer 100. The silencer 100 may be located below the passage portion 17 in the direction of gravity. The silencer 100 may guide a substance discharged through the passage portion 17.

For example, the substance discharged through the passage portion 17 may be air that vibrates to generate noise when flame of the burner 61 is extinguished, may be sparks generated by the burner 61, or may be oil and/or food debris generated from the food in the cooking chamber 20.

The cooking apparatus 1 may include a supporter 18 on which the silencer 100 is mounted. The supporter 18 may extend from a bottom surface of the main body 10. The supporter 18 may extend from the main body 10 by a length shorter than a length that the leg 19 extends from the bottom surface of the main body 10.

The supporter 18 may include a first mounting portion 18a for mounting the silencer 100. For example, the first mounting portion 18a may have a hole shape.

The silencer 100 may include a first noise guide 110. The first noise guide 110 may be located below the passage portion 17 in the direction of gravity. The first noise guide 110 may have a size capable of covering the passage portion 17. The first noise guide 110 may have a size corresponding to an area where the passage portion 17 is formed.

The first noise guide 110 may guide at least a portion of the substance discharged to the outside of the main body 10 through the passage portion 17 in a first direction. The first noise guide 110 may guide at least a portion of the substance discharged through the passage portion 17 to move along the bottom surface of the main body 10. The first noise guide 110 may change a discharge direction of the substance discharged in the direction of gravity through the passage portion 17. For example, in a case where the substance discharged to the outside of the main body 10 through the passage portion 17 is gas, the first noise guide 110 may change the discharge direction of the gas.

The first noise guide 110 may include a first guide body 111 extending in a direction in which the bottom surface of the main body 10 extends. The first guide body 111 may extend approximately parallel to the bottom surface of the main body 10. The first guide body 111 may have a size corresponding to the area where the passage portion 17 is formed. The first guide body 111 may be spaced apart from the bottom surface of the main body 10 and have a predetermined area.

The first noise guide 110 may include a first blocking portion 113 arranged at one end of the first guide body 111. The first blocking portion 113 may prevent a substance in a first flow path P1 from being discharged in a direction opposite to the first direction. The first blocking portion 113 may prevent the substance in the first flow path P1 from being discharged in a second direction. The second direction may be opposite to the first direction. The first blocking portion 113 may limit a discharge direction to discharge the substance in the first flow path P1 in a preset direction. The first blocking portion 113 may be bent from one end of the first guide body 111 and extend toward the main body 10. The first blocking portion 113 may extend in a direction opposite to the direction of gravity from the first guide body 111.

Referring to FIG. 7, the cooking apparatus 1 may include the first flow path P1 through which at least a portion of the substance discharged from the passage portion 17 is guided by the first noise guide 110. The first noise guide 110 may be provided to form the first flow path P1 for guiding at least a portion of the substance discharged to the outside of the main body 10 through the passage portion 17 in the first direction.

Specifically, as the first blocking portion 113 extends in a direction approximately perpendicular to the bottom surface of the main body 10, and as the first guide body 111 is bent and extended from the first blocking portion 113 in a direction approximately parallel to the bottom surface of the main body 10, the first noise guide 110 may form the first flow path P1.

The first flow path P1 may be formed by the main body 10 and the first noise guide 110. When the silencer 100 is mounted on the main body 10, the supporter 18 of the main body 10, the first guide body 111 and the first blocking portion 113 of the first noise guide 110 may form the first flow path P1. The supporter 18 of the main body 10 may cover the front and the rear of the first flow path P1, the first guide body 111 may cover a lower portion of the first flow path P1, and the first blocking portion 113 may cover a right side of the first flow path P1. The substance discharged from the passage portion 17 may flow into an upper portion of the first flow path P1 and move to a left side of the first flow path P1.

The first noise guide 110 may collect at least a portion of the substance discharged to the outside of the main body 10 through the passage portion 17. For example, in a case where the substance discharged to the outside of the main body 10 through the passage portion 17 is fluid or solid, the first noise guide 110 may collect the fluid or solid.

The first noise guide 110 may include a first prevention portion 115 for preventing a portion of the substance in the first flow path P1 from moving to a second noise guide 120. The first prevention portion 115 may be located at an end opposite to one end where the first blocking portion 113 is located on the first guide body 111. The first prevention portion 115 may extend from the first guide body 111 by a length shorter than the length that the first blocking portion 113 extends from the first guide body 111. The first prevention portion 115 and the first blocking portion 113 may extend from the first guide body 111 in approximately the same direction. The first prevention portion 115 may be bent from the end opposite to the one end of the first guide body 111 where the first blocking portion 113 is located, and may extend toward the main body 10. The first prevention portion 115 may extend from the first guide body 111 in a direction opposite to the direction of gravity.

The first noise guide 110 may include an extension portion 117. The extension portion 117 may extend from the first guide body 111 toward the second noise guide 120. The extension part 117 may extend in a direction opposite to the direction in which the first prevention portion 115 and the first blocking portion 113 extend from the first guide body 111.

The first noise guide 110 may include a first coupling portion 118 for coupling with the second noise guide 120. For example, the first coupling portion 118 may have a hole shape.

The silencer 100 may include the second noise guide 120. The second noise guide 120 may be located below the first noise guide 110 in the direction of gravity.

The first noise guide 110 may be coupled to the second noise guide 120. The second noise guide 120 may be coupled to the main body 10.

The second noise guide 120 may guide at least a portion of the substance, guided by the first noise guide 110, in the second direction different from the first direction. For example, the second direction in which the second noise guide 120 guides the substance may be opposite to the first direction in which the first noise guide 110 guides the substance. The second noise guide 120 may change a discharge direction of the substance that has passed through the first noise guide 110. For example, in a case where the substance that has passed through the first flow path P1 and is discharged from the first noise guide 110 is gas, the second noise guide 120 may change the discharge direction of the gas.

The second noise guide 120 may include a second guide body 121 extending in a direction in which the bottom surface of the main body 10 extends. The second guide body 121 may extend approximately parallel to the bottom surface of the main body 10. The second guide body 121 may extend approximately parallel to the first guide body 111. The second guide body 121 may be spaced apart from the bottom surface of the main body 10 and have a predetermined area. The second guide body 121 may be spaced apart from the first guide body 111 and have a predetermined area.

The second noise guide 120 may include a second blocking portion 123 arranged at one end of the second guide body 121. The second blocking portion 123 may prevent a substance in the second flow path P2 from being discharged in a direction opposite to the second direction. The second blocking portion 123 may prevent the substance in the second flow path P2 from being discharged in the first direction. The second blocking portion 123 may limit a discharge direction to discharge the substance in the second flow path P2 in a preset direction. The second blocking portion 123 may be bent from one end of the second guide body 121 and extend toward the main body 10. The second blocking portion 123 may extend from the second guide body 121 in a direction opposite to the direction of gravity. The second blocking portion 123 may be located on one side opposite to the side of the passage portion 17 where the first blocking portion 113 is located.

The cooking apparatus 1 may include the second flow path P2 through which at least a portion of the substance that has passed through the first flow path P1 is guided by the second noise guide 120. The second noise guide 120 may be provided to form the second flow path P2 for guiding at least a portion of the substance, guided by the first noise guide 110, in the second direction different from the first direction.

Specifically, the second blocking portion 123 extends in a direction approximately perpendicular to the bottom surface of the main body 10, and the second guide body 121 is bent from the second blocking portion 123 and extends in a direction approximately parallel to the bottom surface of the main body 10, and thus the second noise guide 120 may form the second flow path P2.

The second flow path P2 may be formed by the first noise guide 110 and the second noise guide 120. When the silencer 100 is mounted on the main body 10, the first guide body 111 and the extension portion 117 of the first noise guide 110 and the second guide body 121 and the second blocking portion 123 of the second noise guide 120 may form the second flow path P2. The first guide body 111 of the first noise guide 110 may cover a portion of an upper portion of the second flow path P2, the extension portion 117 of the first noise guide 110 may cover the front and the rear of the second flow path P2, the second guide body 121 may cover a lower portion of the second flow path P2, and the second blocking portion 123 may cover a left side of the second flow path P2. The substance that has passed through the first flow path P1 may flow into an upper left side of the second flow path P2 and move to a right side of the second flow path P2.

The second noise guide 120 may collect at least a portion of the substance that has passed through the first flow path P1 and is discharged from the first noise guide 110. For example, in a case where the substance that has passed through the first flow path P1 and is discharged from the first noise guide 110 is fluid or solid, the second noise guide 120 may collect the fluid or solid.

The second noise guide 120 may include a second prevention portion 125 for preventing a portion of the substance in the second flow path P2 from being discharged from the second noise guide 120. The second prevention portion 125 may be located at an end opposite to one end where the second blocking portion 123 is located on the second guide body 121. The second prevention portion 125 may extend from the second guide body 121 by a length shorter than a length that the second blocking portion 123 extends from the second guide body 121. The second prevention portion 125 and the second blocking portion 123 may extend from the second guide body 121 in approximately the same direction. The second prevention portion 125 may be bent from the end opposite to the one end of the second guide body 121 where the second blocking portion 123 is located, and may extend toward the main body 10. The second prevention portion 125 may extend from the second guide body 121 in a direction opposite to the direction of gravity.

The second noise guide 120 may include a second coupling portion 128 for coupling with the first noise guide 110. For example, the second coupling portion 128 may have a hole shape.

As the fastening member is fastened to the second coupling portion 128 and the first coupling portion 118 in a state in which the second coupling portion 128 and the first coupling portion 118 are aligned, the first noise guide 110 may be coupled to the second noise guide 120.

The second noise guide 120 may be mounted on the supporter 18 of the main body 10. The second noise guide 120 may include a second mounting portion 129 for coupling to the main body 10. For example, the second mounting portion 129 may have a hole shape.

As the fastening member is fastened to the second mounting portion 129 and the first mounting portion 18a in a state in which the second mounting portion 129 and the first mounting portion 18a are aligned, the second noise guide 120 may be mounted to the main body 10.

The silencer 100 may include a sound absorbing member 130. The sound absorbing member 130 may be disposed on the second flow path P2. The sound absorbing member 130 may be mounted to the second noise guide 120. The sound absorbing member 130 may reduce noise passing through the second flow path P2. The sound absorbing member 130 may absorb a kinetic energy of the noise passing through the second flow path P2. The sound absorbing member 130 may include a flame-retardant material.

The cooking apparatus 1 may include a first sealing member 141 for sealing a gap between the first blocking portion 113 and the main body 10 to prevent the substance in the first flow path P1 from being discharged in the second direction. The first sealing member 141 may prevent the substance that moves from the passage portion 17 to the first flow path P1 from leaking out through the gap between the first blocking portion 113 and the main body 10.

The cooking apparatus 1 may include a second sealing member 142 for sealing a gap between the second blocking portion 123 and the main body 10 to prevent the substance in the second flow path P2 from being discharged in the first direction. The second sealing member 142 may prevent the substance that moves from the first flow path P1 to the second flow path P2 from leaking out through the gap between the second blocking portion 123 and the main body 10.

With reference to FIG. 7, a function of the silencer 100 that guides the substance discharged from the passage portion 17 is described.

For example, in the cooking apparatus 1, when the supply of gas to the burner 61 is stopped and the flame of the burner 61 is extinguished, the flame moves back to the burner 61 and causes an explosion, leading to generation of noise. The noise may be transmitted to the outside of the main body 10 using air as a medium.

Specifically, the noise generated from the burner 61 may be discharged to the outside of the burner case 66 through the case opening 70 of the burner case 66. The noise discharged to the outside of the burner case 66 may be discharged to the outside of the main body 10 through the passage portion 17 of the main body 10. The noise discharged to the outside of the main body 10 may be transmitted to the silencer 100. The vibration of the air is reduced while passing through the first flow path P1, and thus a level of the noise transmitted to the silencer 100 may be reduced.

The noise that has been reduced by passing through the first flow path P1 may be further reduced as the vibration of the air is further reduced while passing through the second flow path P2. The noise passing through the second flow path P2 may be reduced by the sound absorbing member 130. The noise that has passed through the second flow path P2 may be discharged to the outside of the cooking apparatus 1 with a reduced magnitude, compared to the magnitude of the noise generated from the burner 61.

For example, a size of the first flow path P1 may be larger than a size of the second flow path P2. A distance between the main body 10 and the first guide body 111 may be greater than a distance between the first guide body 111 and the second guide body 121. A height of the first flow path P1 in the direction of gravity may be higher than a height of the second flow path P2 in the direction of gravity. A volume of the first flow path P1 may be larger than a volume of the second flow path P2. A cross-sectional area of the first flow path P1 in the direction of gravity may be larger than a cross-sectional area of the second flow path P2 in the direction of gravity.

Because the noise generated from the burner 61 may be first reduced in the first flow path P1, making the size of the first flow path P1 larger than the size of the second flow path P2 may effectively reduce noise.

According to the above configuration, the cooking apparatus 1 according to an embodiment may ensure a flow path that may reduce a level of noise generated by the burner 61 and transmitted to a user, thereby providing consumers with a product of heightened emotional quality.

According to the disclosure, in the cooking apparatus 1, the first noise guide 110 and the second noise guide 120 may form the first flow path P1 and the second flow path P2 which has a different discharge direction from the first flow path P1 in a limited space between the lower portion of the main body 10 and the bottom, thereby efficiently utilizing a space.

For example, in the cooking apparatus 1, sparks generated by the flame of the burner 61 may be discharged to the outside of the main body 10 through the case opening 70 and the passage portion 17. The sparks discharged to the outside of the main body 10 move to the silencer 100. The sparks that have moved to the silencer 100 may be prevented from being discharged from the cooking apparatus 1 by the first noise guide 110 and/or the second noise guide 120.

According to the above configuration, the cooking apparatus 1 according to an embodiment may prevent sparks generated from the flame of the burner 61 from being discharged to the outside of the cooking apparatus 1, thereby improving safety of use.

For example, in the cooking apparatus 1, oil or food debris from the food in the cooking chamber 20 may pass through the heat supply portion 68 and the burner case 66, and may be discharged to the outside of the main body 10 through the case opening 70 and the passage portion 17. The oil or food debris discharged to the outside of the main body 10 moves to the silencer 100. The oil or food debris that has moved to the silencer 100 may be prevented from being discharged from the cooking apparatus 1 by the first noise guide 110 and/or the second noise guide 120.

According to the above configuration, the cooking apparatus 1 according to an embodiment may prevent oil or food debris generated from food in the cooking chamber 20 from being discharged to the outside of the cooking apparatus 1, thereby preventing a surrounding area of the cooking apparatus 1 from being polluted.

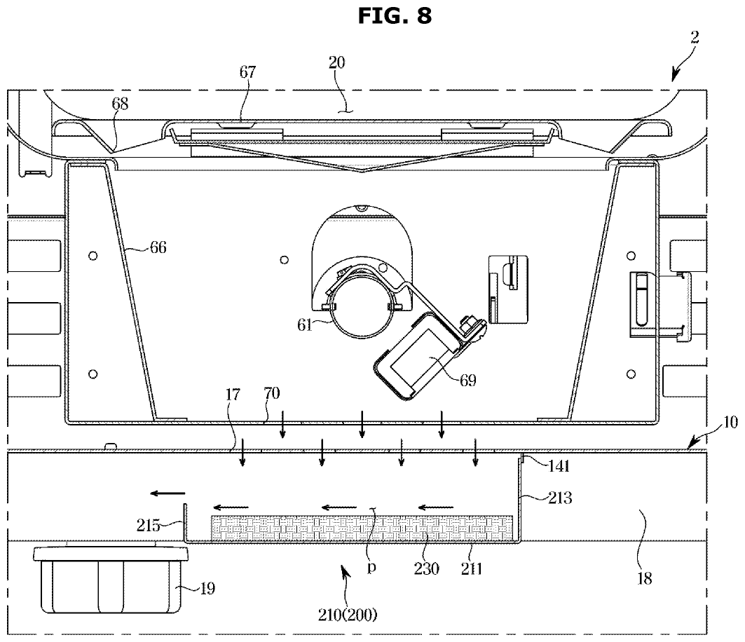

FIG. 8 illustrates a partial cross sectional view of a cooking apparatus including a silencer according to an embodiment.

Referring to FIG. 8, a cooking apparatus 2 including a silencer 200 according to an embodiment of the disclosure is described. In describing the cooking apparatus 2 including the silencer 200 shown in FIG. 8, the same reference numerals are assigned to the same components as in the cooking apparatus 1 including the silencer 100 shown in FIG. 7, and a detailed description thereof is omitted.

Referring to FIG. 8, the cooking apparatus 2 may include the silencer 200 to guide a substance discharged from the passage portion 17. The silencer 100 shown in FIG. 7 may include the first noise guide 110 and the second noise guide 120, while the silencer 200 shown in FIG. 8 may include a single noise guide 210.

The noise guide 210 may guide at least a portion of the substance discharged to the outside of the main body 10 through the passage portion 17 in the first direction. The noise guide 210 may change a discharge direction of the substance discharged in the direction of gravity through the passage portion 17. For example, in a case where the substance discharged to the outside of the main body 10 through the passage portion 17 is gas, the noise guide 210 may change the discharge direction of the gas.

The noise guide 210 may include a guide body 211. The guide body 211 may extend in a direction in which a bottom surface of the main body 10 extends. The guide body 211 may have a size corresponding to an area where the passage portion 17 is formed.

The cooking apparatus 2 may include a flow path P through which at least a portion of the substance discharged from the passage portion 17 is guided by the noise guide 210. The noise guide 210 may be provided to form the flow path P for guiding at least a portion of the substance discharged to the outside of the main body 10 through the passage portion 17 in the first direction.

The flow path P may be formed by the main body 10 and the noise guide 210. The substance discharged from the passage portion 17 may flow into an upper portion of the flow path P and move to a left side of the flow path P.

The noise guide 210 may include a blocking portion 213 provided at one end of the guide body 211. The blocking portion 213 may prevent the substance in the flow path P, formed by the noise guide 210 and the main body 10, from being discharged in a direction opposite to the first direction. The blocking portion 213 may prevent the substance in the flow path P from being discharged in the second direction. The second direction may be opposite to the first direction. The blocking portion 213 may limit a discharge direction to discharge the substance in the flow path P in a preset direction.

The noise guide 210 may collect at least a portion of the substance discharged to the outside of the main body 10 through the passage portion 17. For example, in a case where the substance discharged to the outside of the main body 10 through the passage portion 17 is fluid or solid, the noise guide 210 may collect the fluid or solid.

The noise guide 210 may include a prevention portion 215 for preventing a portion of the substance in the flow path P from being discharged from the noise guide 210. The prevention portion 215 may be located at an end opposite to one end where the blocking portion 213 is located on the guide body 211.

The silencer 200 may further include a sound absorbing member 230. The sound absorbing member 230 may reduce noise passing through the flow path P. The sound absorbing member 230 may be omitted.

According to the above configuration, the cooking apparatus 2 according to an embodiment may ensure the flow path that may reduce a level of noise generated by the burner 61 and transmitted to a user, thereby providing consumers with a product of heightened emotional quality.

According to the above configuration, the cooking apparatus 2 according to an embodiment may prevent sparks generated from the flame of the burner 61 from being discharged to the outside of the cooking apparatus 2, thereby improving safety of use.

According to the above configuration, the cooking apparatus 2 according to an embodiment may prevent oil or food debris generated from food in the cooking chamber 20 from being discharged to the outside of the cooking apparatus 2, thereby preventing a surrounding area of the cooking apparatus 2 from being polluted.

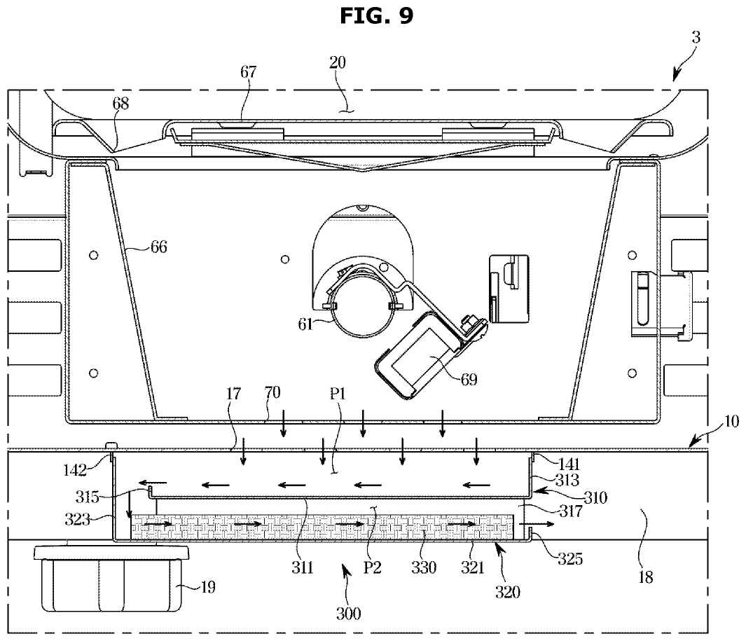

FIG. 9 illustrates a partial cross sectional view of a cooking apparatus including a silencer according to an embodiment.

Referring to FIG. 9, a cooking apparatus 3 including a silencer 300 according to an embodiment of the disclosure is described. In describing the cooking apparatus 3 including the silencer 300 shown in FIG. 9, the same reference numerals are assigned to the same components as in the cooking apparatus 1 including the silencer 100 shown in FIG. 7, and a detailed description thereof is omitted.

Referring to FIG. 9, the cooking apparatus 3 may include the silencer 300 to guide a substance discharged from the passage portion 17. The silencer 100 shown in FIG. 7 is provided to correspond to an area where the passage portion 17 is formed, but the silencer 300 shown in FIG. 9 may have a larger size than an area where the passage portion 17 is formed. A length of the silencer 300 shown in FIG. 9 may extend further to the left, compared to the silencer 100 shown in FIG. 7.

Referring to FIG. 9, the silencer 300 may include a first noise guide 310, a second noise guide 320, and a sound absorbing member 330.

The first noise guide 310 and the main body 10 may form a first flow path P1. The second noise guide 320 and the first noise guide 310 may form a second flow path P2.

The first noise guide 310 may include a first guide body 311, a first blocking portion 313 and a first prevention portion 315. Here, the first guide body 311 is for guiding at least a portion of the substance discharged to the outside of the main body 10 through the passage portion 17 in the first direction, the first blocking portion 313 is for limiting a discharge direction to discharge at least a portion of the substance passing through the first flow path P1 in a preset direction, and the first prevention portion 315 is for preventing at least a portion of the substance in the first flow path P1 from being discharged from the first noise guide 310. The first noise guide 310 may include an extension portion 317 to form the second flow path P2.

The second noise guide 320 may include a second guide body 321, a second blocking portion 323 and a second prevention portion 325. Here, the second guide body 321 is for guiding at least a portion of the substance passing through the first flow path P1 in the second direction, the second blocking portion 323 is for limiting a discharge direction to discharge at least a portion of the substance passing through the second flow path P2 in a preset direction, and the second prevention portion 325 is for preventing at least a portion of the substance in the second flow path P2 from being discharged from the second noise guide 320.

According to the above configuration, the cooking apparatus 3 according to an embodiment may ensure the flow path that may reduce a level of noise generated by the burner 61 and transmitted to a user, thereby providing consumers with a product of heightened emotional quality.

According to the above configuration, the cooking apparatus 3 according to an embodiment may prevent sparks generated from the flame of the burner 61 from being discharged to the outside of the cooking apparatus 3, thereby improving safety of use.

According to the above configuration, the cooking apparatus 3 according to an embodiment may prevent oil or food debris generated from food in the cooking chamber 20 from being discharged to the outside of the cooking apparatus 3, thereby preventing a surrounding area of the cooking apparatus 3 from being polluted.

The silencer 300 shown in FIG. 9 may secure a longer flow path to reduce a level of noise, compared to the silencer 100 shown in FIG. 7, thereby effectively reducing the noise discharged to the outside of the cooking apparatus 3.

The silencer 300 according to the disclosure is not limited to extending to the left as shown in FIG. 9, and may extend in other directions as long as its length may be extended.

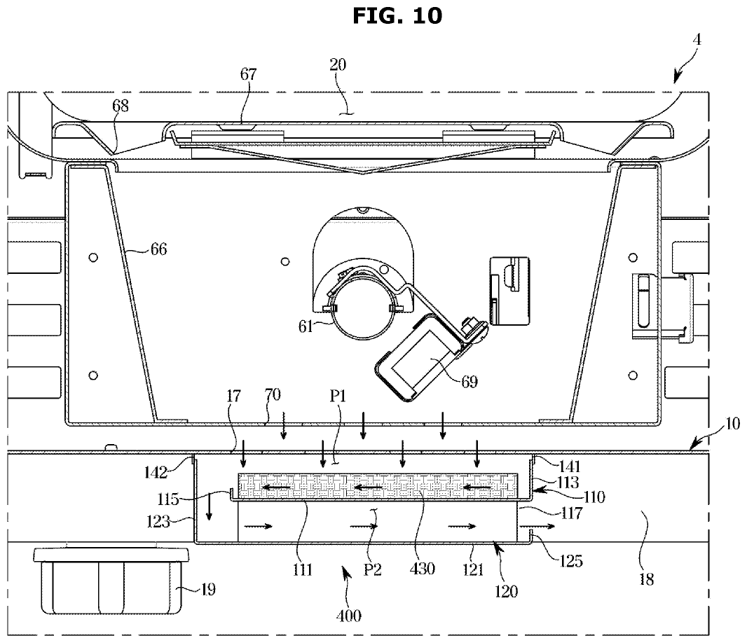

FIG. 10 illustrates a partial cross sectional view of a cooking apparatus including a silencer according to an embodiment.

Referring to FIG. 10, a cooking apparatus 4 including a silencer 400 according to an embodiment of the disclosure is described. In describing the cooking apparatus 4 including the silencer 400 shown in FIG. 10, the same reference numerals are assigned to the same components as in the cooking apparatus 1 including the silencer 100 shown in FIG. 7, and a detailed description thereof is omitted.

Referring to FIG. 10, the cooking apparatus 4 may include the silencer 400. The configuration of the first noise guide 110 and the second noise guide 120 of the silencer 400 shown in FIG. 10 is the same as that of the first noise guide 110 and the second noise guide 120 of the silencer 100 shown in FIG. 7.

The sound absorbing member 130 of the silencer 100 shown in FIG. 7 is located on the second flow path P2, but a sound absorbing member 430 of the silencer 400 shown in FIG. 10 may be located on a first flow path P1.

In the cooking apparatus 4 shown in FIG. 10, noise discharged through the case opening 70 and the passage portion 17 may be first reduced through the sound absorbing member 430 in the first flow path P1.

According to the above configuration, the cooking apparatus 4 according to an embodiment may ensure the flow path that may reduce a level of noise generated by the burner 61 and transmitted to a user, thereby providing consumers with a product of heightened emotional quality.

According to the above configuration, the cooking apparatus 4 according to an embodiment may prevent sparks generated from the flame of the burner 61 from being discharged to the outside of the cooking apparatus 4, thereby improving safety of use.

According to the above configuration, the cooking apparatus 4 according to an embodiment may prevent oil or food debris generated from food in the cooking chamber 20 from being discharged to the outside of the cooking apparatus 4, thereby preventing a surrounding area of the cooking apparatus 2 from being polluted.

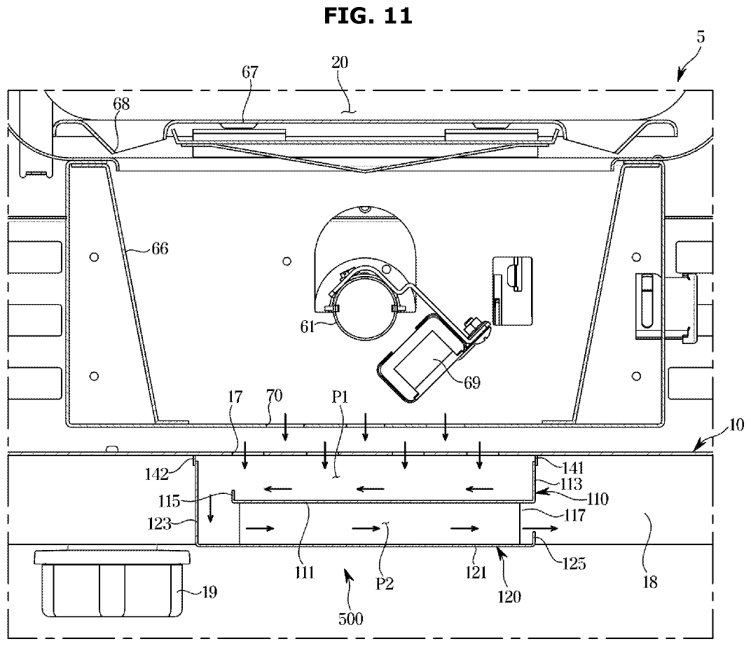

FIG. 11 illustrates a partial cross sectional view of a cooking apparatus including a silencer according to an embodiment.

Referring to FIG. 11, a cooking apparatus 5 including a silencer 500 according to an embodiment of the disclosure is described. In describing the cooking apparatus 5 including the silencer 500 shown in FIG. 11, the same reference numerals are assigned to the same components as in the cooking apparatus 1 including the silencer 100 shown in FIG. 7, and a detailed description thereof is omitted.

Referring to FIG. 11, the cooking apparatus 5 may include the silencer 500. The configuration of the first noise guide 110 and the second noise guide 120 of the silencer 500 shown in FIG. 11 is the same as that of the first noise guide 110 and the second noise guide 120 of the silencer 100 shown in FIG. 7.

The sound absorbing member 130 of the silencer 100 shown in FIG. 7 may be omitted from the silencer 500 shown in FIG. 11. The silencer 500 shown in FIG. 11 may include only components for securing a flow path that may reduce a level of noise.

According to the above configuration, the cooking apparatus 5 according to an embodiment may ensure the flow path that may reduce a level of noise generated by the burner 61 and transmitted to a user, thereby providing consumers with a product of heightened emotional quality.

According to the above configuration, the cooking apparatus 5 according to an embodiment may prevent sparks generated from the flame of the burner 61 from being discharged to the outside of the cooking apparatus 5, thereby improving safety of use.

According to the above configuration, the cooking apparatus 5 according to an embodiment may prevent oil or food debris generated from food in the cooking chamber 20 from being discharged to the outside of the cooking apparatus 5, thereby preventing a surrounding area of the cooking apparatus 5 from being polluted.

According to the disclosure, the cooking apparatus may include: the main body 10 forming the cooking chamber 20; the burner 61 configured to heat the cooking chamber; the passage portion 17 configured to communicate an inside of the main body with an outside of the main body to supply air to the burner; and the silencer 100 configured to reduce noise discharged through the passage portion, while the noise generated from the burner is discharged to the outside of the main body through the passage portion, the silencer being mounted to the main body to cover the passage portion.

The silencer may include the first noise guide 110 configured to guide the noise, discharged to the outside of the main body through the passage portion, in a first direction, and the second noise guide 120 configured to guide the noise, guided by the first noise guide, in a second direction different from the first direction.

The cooking apparatus may include a first flow path P1 to which the noise, discharged from the passage portion, is guided by the first noise guide, and a second flow path P2 to which the noise that has passed through the first flow path is guided by the second noise guide.

The cooking apparatus may further include the sound absorbing member 130 disposed on the second flow path.

The sound absorbing member may include a flame-retardant material.

The first flow path may be formed by the main body and the first noise guide, and the second flow path may be formed by the first noise guide and the second noise guide.

The first noise guide may include the first guide body 111 spaced apart from a bottom surface of the main body and having a predetermined area, and the first blocking portion 113 configured to prevent a substance in the first flow path from being discharged in the second direction. The second noise guide may include the second guide body 121 spaced apart from the first guide body and having a predetermined area, and the second blocking portion 123 configured to prevent a substance in the second flow path from being discharged in the first direction.

The cooking apparatus may further include the first sealing member 141 configured to seal a gap between the main body and the first blocking portion to prevent the noise in the first flow path from being discharged in the second direction.

The cooking apparatus may further include the second sealing member 142 configured to seal a gap between the main body and the second blocking portion to prevent the noise in the second flow path from being discharged in the first direction.

The first noise guide may include the first prevention portion 115 configured to prevent a portion of a substance located in the first flow path from moving to the second noise guide.

The second noise guide may include the second prevention portion 125 configured to prevent a portion of a substance located in the second flow path from being discharged from the second noise guide.

The passage portion may be located below the burner in a direction of gravity. The first noise guide may be located below the passage portion in the direction of gravity. The second noise guide may be located below the first noise guide in the direction of gravity.

The cooking apparatus may further include the burner case 66 located below the cooking chamber to accommodate the burner. The burner case may include the case opening 70 formed to discharge the noise generated from the burner toward the passage portion.

The burner may be located below the cooking chamber in the direction of gravity.

The first noise guide may be coupled to the second noise guide, and the second noise guide may be coupled to the main body.

According to the disclosure, the cooking apparatus may include: the main body 10 forming the cooking chamber 20; the burner 61 located below the cooking chamber and configured to heat the cooking chamber; the passage portion 17 located below the burner to supply air to the burner; and the silencer 200 configured to reduce noise discharged to an outside of the main body through the passage portion and including the guide body 211 spaced apart from a bottom surface of the main body and having a predetermined area and the blocking portion 213 configured to limit a discharge direction so as to discharge a substance discharged to the outside of the main body in a preset direction.

The cooking apparatus may further include a flow path P formed by the main body and the guide to allow the noise discharged from the passage portion to be guided by the guide. The guide may include the prevention portion 215 for preventing a portion of the substance in the flow path P from being discharged from the guide.

The cooking apparatus may further include the sound absorbing member 230 disposed on the flow path P and including a flame-retardant material.

The guide may have a size to cover the passage portion.

According to the disclosure, the cooking apparatus may include: the main body 10 forming the cooking chamber 20; the burner 61 located below the cooking chamber and configured to heat the cooking chamber; the passage portion 17 located below the burner to supply air to the burner; the first noise guide 110 located below the passage portion and configured to form a first flow path P1 for guiding noise discharged to an outside of the main body through the passage portion in a first direction; and the second noise guide 120 configured to form a second flow path P2 for guiding the noise, guided by the first nose guide, in a second direction different from the first direction.

According to the disclosure, the cooking apparatus may include a noise flow path that may suppress and discharge noise generated when a burner flame is extinguished, thereby reducing a level of the noise generated when the burner flame is extinguished.

According to the disclosure, the cooking apparatus may include a silencer located below a passage portion for supplying air to a burner, thereby preventing sparks generated from the flame of the burner from being discharged to the outside of the cooking apparatus.

According to the disclosure, the cooking apparatus may include a silencer located below a passage portion for supplying air to a burner, thereby preventing oil or food debris generated from food from being discharged to the outside of the cooking apparatus.

The effects that can be achieved by the disclosure are not limited to the above-mentioned effects, and other effects not mentioned will be clearly understood by one of ordinary skill in the technical art to which the disclosure belongs from the following description.

Although the disclosure has been shown and described in relation to specific embodiments, it would be appreciated by those skilled in the art that changes and modifications may be made in these embodiments without departing from the principles and scope of the disclosure, the scope of which is defined in the claims and their equivalents.

1. A cooking apparatus, comprising:
a main body including at least one opening, the main body forming a cooking chamber;
a burner in the main body to heat the cooking chamber; and
a silencer mounted to the main body and covering the at least one opening so that:
air from an outside of the main body is passable through the silencer and the at least one opening to be supplied to the burner, and
noise generated by the burner, and discharged through the silencer and the at least one opening to the outside of the main body, is reduced by the silencer.

2. The cooking apparatus of claim 1, wherein
the silencer includes:
a first noise guide configured to guide the noise, discharged through the silencer and the at least one opening, in a first direction, and
a second noise guide configured to guide noise, guided by the first noise guide, in a second direction different from the first direction.

3. The cooking apparatus of claim 2, further comprising:
a first flow path along which the noise, discharged through the silencer and the at least one opening, is guided by the first noise guide; and
a second flow path along which the noise, guided by the first noise guide, is guided by the second noise guide.

4. The cooking apparatus of claim 3, further comprising:
a sound absorbing member disposed in the second flow path so that noise, guided by the second noise guide along the second flow path, is absorbed by the sound absorbing member.

5. The cooking apparatus of claim 4, wherein the sound absorbing member includes a flame-retardant material.

6. The cooking apparatus of claim 3, wherein
the first flow path is formed by the main body and the first noise guide, and
the second flow path is formed by the first noise guide and the second noise guide.

7. The cooking apparatus of claim 3, wherein
the first noise guide includes:
a first guide body spaced apart from a bottom surface of the main body, and
a first blocking portion extended toward the main body to prevent a substance in the first flow path from being discharged in the second direction from the first flow path to an outside of the silencer, and
the second noise guide includes:
a second guide body spaced apart from the first guide body, and
a second blocking portion extended toward the main body to prevent a substance in the second flow path from being discharged in the first direction from the second flow path to the outside of the silencer.

8. The cooking apparatus of claim 7, further comprising:
a first sealing member configured to seal a gap between the main body and the first blocking portion to prevent noise, guided by the first noise guide along the first flow path, from being discharged in the second direction from the first flow path to the outside of the silencer through the gap.

9. The cooking apparatus of claim 7, further comprising:
a second sealing member configured to seal a gap between the main body and the second blocking portion to prevent noise, guided by the second noise guide along the second flow path, from being discharged in the first direction from the second flow path to the outside of the silencer through the gap.

10. The cooking apparatus of claim 3, wherein the first noise guide includes a first prevention portion extending toward the main body to prevent a portion of a substance moved in the first flow path from moving to the second noise guide.

11. The cooking apparatus of claim 3, wherein the second noise guide includes a second prevention portion extending toward the main body to prevent a portion of a substance moved in the second flow path from being discharged from the second noise guide.

12. The cooking apparatus of claim 2, wherein
the at least one opening is located below the burner in a direction of gravity,
the first noise guide is located below the at least one opening in the direction of gravity, and
the second noise guide is located below the first noise guide in the direction of gravity.

13. The cooking apparatus of claim 1, further comprising:
a burner case located below the cooking chamber to accommodate the burner,
wherein the burner case comprises a case opening formed to discharge the noise generated by the burner toward the at least one opening.

14. The cooking apparatus of claim 1, wherein the burner is located below the cooking chamber in a direction of gravity.

15. The cooking apparatus of claim 2, wherein
the first noise guide is coupled to the second noise guide, and
the second noise guide is coupled to the main body.
